(19) United States
(12) Patent Application Publication
(10) Pub. No.: US 2006/0083869 A1
(43) Pub. Date: Apr. 20, 2006

(54) DAL spinner

(76) Inventor: David A. Laudick, Kokomo, IN (US)

Correspondence Address: FRANK D. LACHENMAIER, 116 NORTH MAIN STREET, P. O. BOX 1047, KOKOMO, IN, 46903-1047, US

(21) Appl. No.: 10/966,613

(22) Filed: Oct. 15, 2004

(51) Int. Cl. G09F 17/00; G09F 1/00; B23P 9/00

(52) U.S. Cl. 428/7; 428/687; 40/421; 40/124.05; 40/424

(57) ABSTRACT

This invention generally relates to decorative spinners. More specifically, this invention relates to a spinner apparatus rotated about its vertical axis, either by wind blowing across its face or in a second embodiment, spun by a motor drive unit. The spinner apparatus consists of a number or set of letters or other decorative symbol or logo on or in a pad centered between concentric bands of tinted transparent material coated metal which are connected at the top and bottom and progressively radially displaced about their vertical axis as they approach the inner band. When the device is spun either by the wind blowing it or by an electric motor, the numbers, letters or symbols stand out and appear to be stationary in the line of sight of the viewer and the bands progressively rotated off the plane of the outside band and the center detail provide an interesting wind catching and light reflecting three dimensional shape. When the spinning apparatus is lighted at night it takes on an electric glow appearance and the light appears to move either from the center outward or from the outside inward depending on the direction of rotation.

### BACKGROUND

1. Field of Invention

This invention generally relates to decorative spinners. More specifically, this invention relates to a spinner apparatus rotated about its vertical axis, either by wind blowing across its face or in a second embodiment, spun by a motor drive unit. The spinner apparatus consists of a number or set of letters or other decorative symbol or logo on or in a pad centered between concentric bands of tinted transparent material coated metal which are connected at the top and bottom and progressively radially displaced about their vertical axis as they approach the inner track. When the device is spun either by the wind blowing it or by an electric motor, the numbers, letters or symbols stand out and appear to be stationary in the line of sight of the viewer and the bands progressively rotated off the plane of the outside track and the center detail provide an interesting wind catching and light reflecting three dimensional shape. When the spinning apparatus is lighted at night it takes on an electric glow appearance and the light appears to move either from the center outward or from the outside inward depending on the direction of rotation.

2. Prior Art

U.S. Pat. No. D410,214 Nielsen 1999 discloses different shapes of off center pivoting devices in the form of a circle, a square and an ellipse which spin about their vertical axis when the wind blows against their surfaces. U.S. Pat. No. 3,818,629 Davidson 1974, U.S. Pat. No. 4,582,497 Lyons 1986 and U.S. Pat. No. 6,422,913 Trejo 2002 demonstrate pinwheel devices that rotate about their horizontal axis when driven by wind blowing into their faces.

A number of patents cover kinetic light reflectors or sculptures that move when actuated by wind blowing across their surfaces such as U.S. Pat. No. D479,482 Seeders 2003, U.S. Pat. No. D480,015 Coulter 2003, U.S. Pat. No. D480,325 Bull 2002 and U.S. Pat. No. 6,258,420 Lehman.

U.S. Pat. No. 6,209,247 Boccanfuso 2001 discloses a flat stamped ornament frame with an opening in the center into which is inserted an ornament with an upper and lower pivotal mounting arrangement. 20030061752 Rogers 2003 takes this concept further by etching the center inset from the same blank material that the frame is etched or stamped from and then twisting that center section connecting arms.

Finally, U.S. Pat. No. 4,215,194 Shepherd 1980 shows a method for chemically milling flat sheet metal to form a three dimensional object comprising masking and etching metal to form a design leaving tabs and score lines. The tabs and score lines allow certain design portions to be bent to different planes to achieve a three dimensional appearance.

### SUMMARY

The prior art shows a number of wind driven rotary devices, but none shown have the feature of being able to read or discern the identity of the center detail while the decorative ornament is spinning and none have the interesting moving light patterns generated by the DAL Spinner.

Objectives:

The objectives of the DAL Spinner are: 1) to provide a spinner apparatus and method of making same such that the center detail or feature of the decorative ornament appears to be stationary in the plane of view of the observer at eye level from any direction while spinning; 2) to provide a spinner apparatus and method of making same such that the center feature of the decorative ornament can be a set of numbers such as a house number, a word or set of letters designating a person or company, a favorite player or drivers number, a university or pro-team logo or any of the standard holiday ornaments such as Christmas trees, stars, angels etc.; 3) to provide a spinner apparatus and method of making same such that the center feature is surrounded by concentric bands separated by fine cuts except where they remain attached at the top and bottom of each band and the top and bottom of the center feature; 4) to provide a spinner apparatus and method of making same such that the intermediate bands are progressively radially displaced about the vertical axis in small incremental angles from the plane of the outer band, the inner band and the center feature, giving the decorative ornament a three dimensional form; 5) to provide a spinner apparatus and method of making same such that the decorative ornament is formed economically by stamping, electrical discharge machining, laser or water jet cutting or chemical etching from a flat sheet of malleable metal that can be sanded providing light reflecting patterns and coated with a tinted transparent material; 6) to provide a spinner apparatus and method of making same such that the detail in the center section can be produced by cutting into the center pad with any of the conventional metal removing techniques or be added to a solid center panel with stickers, painting or printing; 7) to provide a spinner apparatus and method of making same such that it can be spun by wind blowing across its surface or by a decorative ornament display unit with an electric motor and a display light.

DAL Spinner is illustrated in two embodiments which meet the preceding objectives. The first is a DAL Spinner ornament mounted in a “C” frame with top and bottom bearings that allow the ornament to rotate when the wind blows across its surface where the “C” frame mounting “U” clamp is shown in phantom lines for illustrative purposes and is not claimed as part of this invention. This could be a stationary mount such as for a house number or could be mounted on a moving boat, automobile or motorcycle using the relative air motion to provide the spinning force. The second embodiment involves the same design decorative ornament but here it is mounted on a display unit with a 12 or 110 volt motor to rotate the ornament. This embodiment can also contain a light mounted in the base to shine on the reflective surfaces of the ornament and a switch for the motor and/or a combo switch for the motor and the light.

In these two embodiments the ornament is formed from a flat sheet of malleable metal wherein the outer periphery is selected from the group of round, oval, square, rectangular, pentagon, hexagon, octagon, heart or cloud shaped with a plurality of similarly shaped inscribed concentric bands circumscribing a center panel or feature where the outer band, the inner band and the center panel are all on the same plane and the intermediate bands are progressively radially displaced about the vertical axis, giving the apparatus its three dimensional form.

### DRAWINGS

In order that the invention may be more fully understood it will now be described by way of example, with reference to the accompanying drawings in which

FIG. 1 is a front view of the decorative ornament as stamped, etched, laser or water jet cut or machined in the flat.

FIG. 1A is a front view of the decorative ornament as stamped, etched, laser cut or machined in the flat where the center section is left solid and the desired artwork is added by attaching an adhesive backed logo or sticker or painting or printing on the center section.

FIG. 2 is a top view of the decorative ornament in its rotated three dimensional shape.

FIG. 3 is a side view of a typical decorative ornament mounted in a wind driven “C” frame support.

FIG. 4 is a top view of a typical decorative ornament mounted in a display unit.

FIG. 5 is a side view of a typical decorative ornament mounted in a display unit.

FIG. 6 is a perspective view of a display unit.

### REFERENCE NUMERALS

10—DAL Spinner

12—“C” frame mount

14—wire-swivel-lanyard assembly

16—decorative ornament

18—decorative ornament display unit

20—motor

22—suspension hook

24—support shaft

26—base

28—control switch

30—display light

32—power cord and plug

34—progressively rotated band

36—interconnect bars

38—concentric bands

40—center feature

42—outer band

44—band separation cuts

46—center panel sticker

48—inner band

50—suspension hole

52—Mounting “U” clamp

### DETAILED DESCRIPTION

In order that the invention may be more fully understood, it will now be described by way of example with reference to the accompanying drawings which represent and illustrate both embodiments of DAL Spinner 10. DAL Spinner 10 can be utilized with passive “C” frame mount 12 and let the wind spin it or it can be used with motor driven, lighted decorative ornament display unit 18.

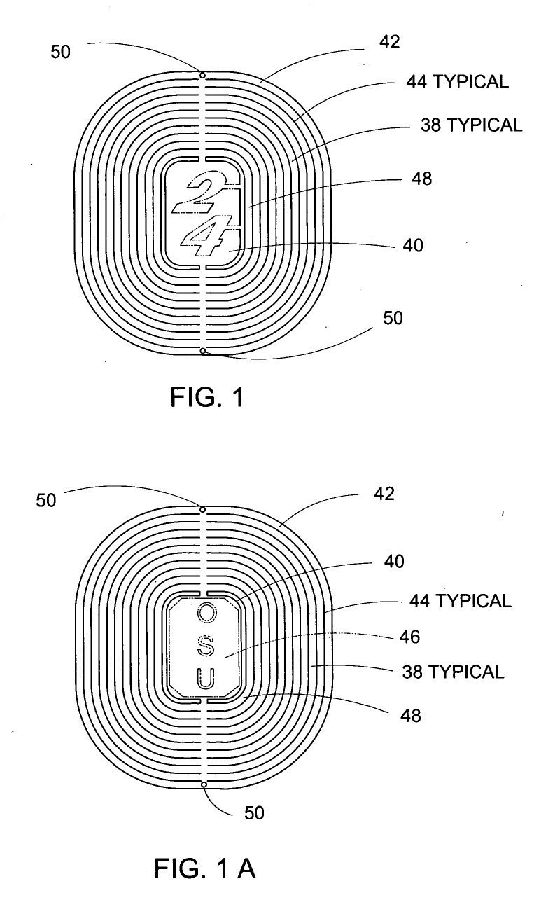

Turning to FIG. 1, decorative ornament 16 is shown in its stamped, etched, laser cut or machined flat state. Concentric bands 38 are divided by band separation cuts 44, the width of which are determined by the technology used for fabrication. The preferred embodiment utilizes a laser cut technique which generates a clearance between bands of approximately 0.005 inches. The space between inner band 48 and center feature 40 is approximately 0.25 inches which tends to highlight center feature 40. Separation cuts 44 stop approximately 0.125 inches from the top and bottom center of decorative ornament 16, leaving interconnect bars 36 top and bottom that connect each of concentric bands 38 to center feature 40. This view shows pivot suspension holes 50 from which ornament 16 will be suspended in its application. The numerals 2 and 4, shown in phantom lines, are for illustration only and show an example of a feature that can be stamped, etched, laser or water jet cut or machined into center feature 40. While still in this flat stage, front and back surfaces are sanded with a stroke perpendicular to the axis between suspension holes 50 which leaves reflective striations.

FIG. 1A shows decorative ornament 16 also in its flat first stage of fabrication where center feature 40 is a solid pad and artwork can be added to it by placing of center panel sticker 46 or painting or printing on both sides.

FIG. 2 shows decorative ornament 16 in the second stage of its construction. Outer band 42, inner band 48 and center feature 40 remain in the same plane and progressively rotated bands 34 are shown each progressively radially displaced about interconnect bars 36 from the adjacent intermediate concentric band 38. The second band from the outside is only displaced a small angle, with each adjacent track rotated a like amount, progressing to the second to innermost band. Larger DAL Spinners 10 bands 38 are displaced with appropriately larger angles. After rotated bands 34 are set, the ornament is coated with a tinted transparent material allowing the sanded-in striations to reflect light through the coating material to enhance the viewing pleasure. Powder coating with metallic flakes in the powdered material and other paints or platings would also be alternatives considered for specific applications.

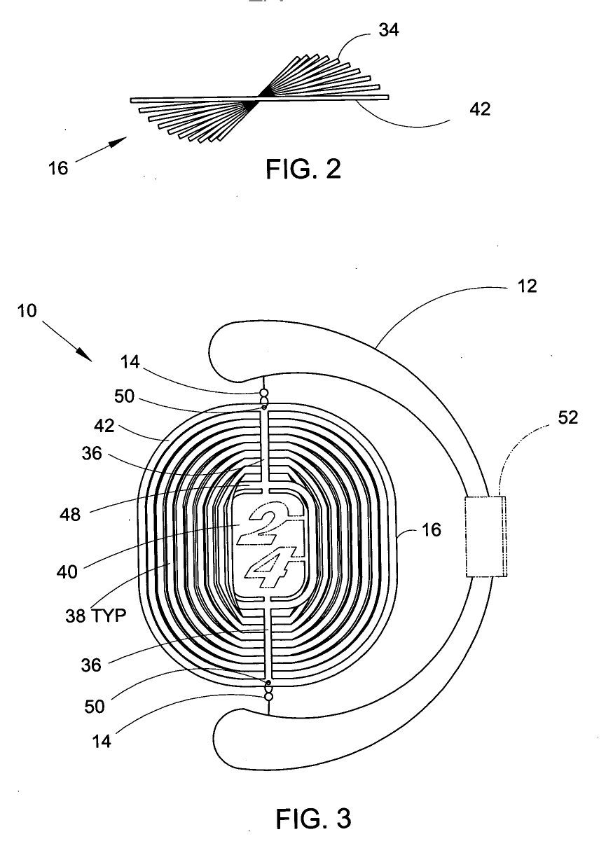

FIG. 3 shows a side view of a typical decorative ornament 16 in wind driven “C” frame mount 12 where ornament 16 is suspended between wire-swivel-lanyard assemblies 14 attached to the top and bottom of “C” frame 12. Mounting “U” clamp 52 is shown in phantom lines and is not claimed as part of this invention.

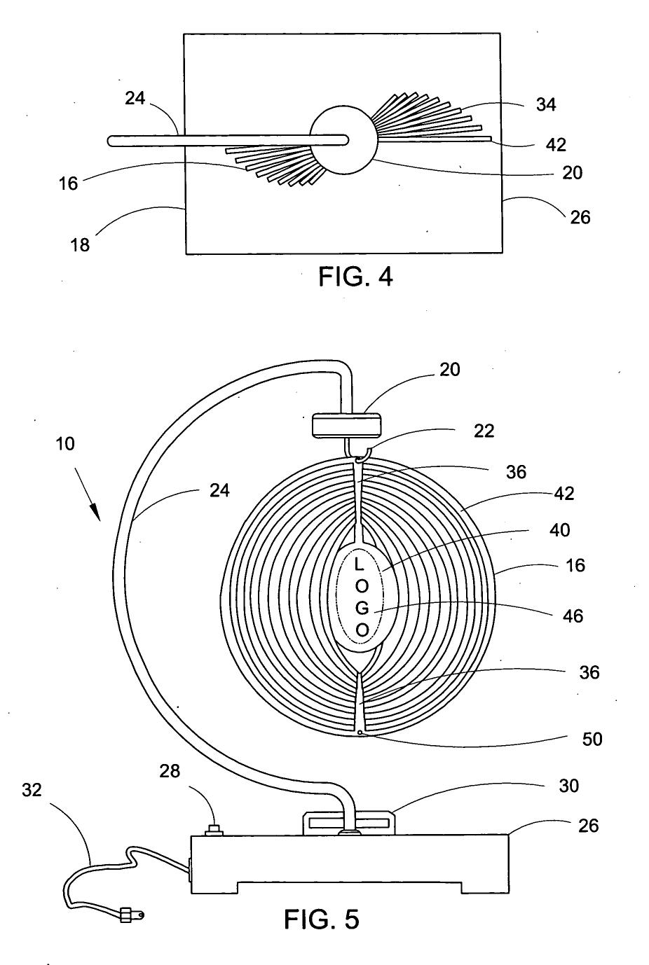

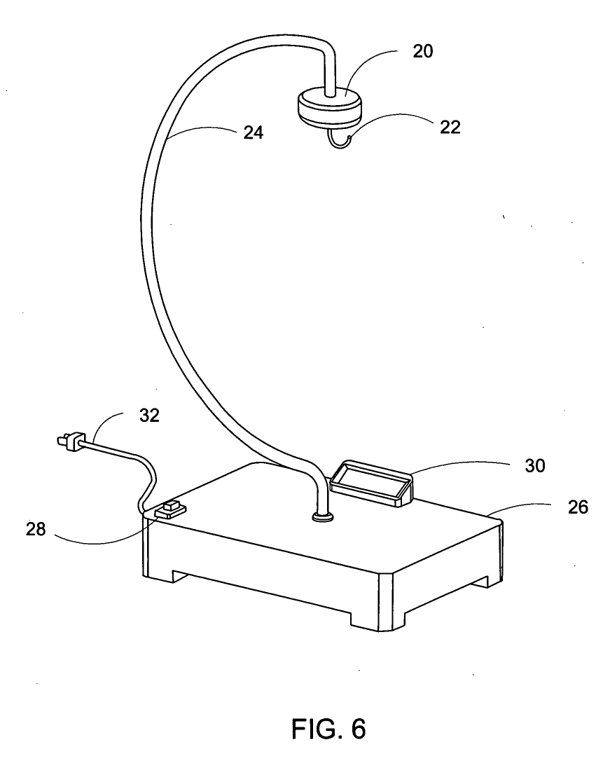

FIG. 6 shows a perspective view of a typical ornament display unit 18 and FIGS. 4 and 5 show a top view and a side view with a typical decorative ornament 16 mounted. Ornament 16 is hung on suspension hook 22 which is rotated by motor 20 that is attached to the proximal end of support shaft 24. Support shaft 24 can have different lengths and curvature radii to support but not interfere with the rotation of different size and shape decorative ornaments 16. Support shaft 24 is attached at its distal end to rectangular base 26 and is a hollow tube allowing the motor wires to be routed internally through it and base 26 to switch 28. Motor 20 can be either a 12 volt or a 110 volt system depending on application. Rectangular base 26 can be made of any conventional materials such as wood, plastic or metal and is constructed with sufficient cross sectional area and mass as to stably support the varying size of spinning ornaments for a particular design. Base 26 can have display light 30 and control switch 28 mounted somewhere on its top surface. Display light 30 illuminates the sanded-in striations or the reflective coating on decorative ornament 16 and switch 28 can be a combo switch that turns motor 20 and light 30 on and off. There can be separate switches for each and switch 28 can be a rheostat which can adjust the rotation speed of motor 20. If the unit is a conventional 110 volt system, extension cord and plug 32 is connected under the base to switch 28 and if a 12 volt motor is used a 110 volt inverter can be used to for power.

The preceding descriptions are for illustrative purposes and are not intended to limit the scope of this invention. One skilled in these fabrication arts will see many options for material thickness, periphery shape and dimension, motor size, base dimensions, masses, material selections and finishes and lamp and switch combinations that fit within the scope of this invention. The scope of the invention should be determined by the appended claims rather than by the specific examples given.

The invention claimed is:

1. An ornament comprising:
a vertical axis spinner ornament formed from a flat sheet of malleable metal with a front and back surface, a perimeter selected from the group of round, oval, square, rectangular, pentagon, hexagon, octagon, heart or cloud shape forming the outside of an external band and the inside of said external band being likewise shaped, with mounting holes in the center of said external band at the top and bottom, a plurality of intermediate concentric like shaped bands, an internal band and a center panel or pad also similarly shaped;
said bands of said malleable metal are separated from each other by fine cuts except where said bands are connected in the center at the top and bottom of said ornament;
said front and back surfaces are sanded with the direction of sanding grain perpendicular to the axis running through the top and bottom mounting holes;
said external band, said internal band and said panel are in a common plane while the planes of said intermediate bands are radially displaced progressively away from the plane of said external band with the first intermediate track rotated about the vertical axis at an angle from the external band and each subsequent intermediary track a rotated a like radial displacement, giving said ornament a three dimensional form;
said center panel displays a number, decoration or logo; and
said spinner ornament is coated with transparent tinted material.

2. An ornament as in claim 1 wherein
said transparent tinted material is selected from a group of metallic paint, powder coat, or plating.

3. An ornament as in claim 1 wherein
said center panel has text or artwork cut through its surface utilizing a technology selected from the group consisting of etching, stamping, machining, laser or water jet cutting.

4. An ornament as in claim 1 wherein
said center panel has text or artwork painted or printed on or adhesively attached in decal or sticker form.

5. A rotatable display, comprising:
a “C” frame mounting bracket with a top and bottom pivot support between which said ornament is suspended by wires from said pivot supports to ball swivels and connected between said ball swivels and lanyard type clasps hooked into said mounting holes, wherein said ornament is adapted to spin about its vertical axis when the surfaces of said bands are impinged by relative air motion caused by wind blowing or placing ornament on the exterior of a moving vehicle.

6. A rotatable display as in claim 5, comprising:
a lighted, motor driven decorative ornament display unit upon which said ornament is hung on a suspension hook and wherein said ornament is adapted to spin about its vertical axis when said suspension hook is rotated by a motor which is attached to the proximal end of a support shaft that is attached at its distal end to a rectangular base and is a curved hollow tube with a curvature radius sufficient to clear said spinning ornament chosen, allowing said motor wires to be routed internally from said motor through said base to a switch or rheostat; and
a light that is mounted on the top surface of said base is wired into a switch selected from the group of an on-off switch for said motor, an on-off switch for said light, a combination on-off switch for both and a separate light switch whereby the spinning ornament is illuminated.

7. A rotatable display as in claim 6 wherein said rectangular base is constructed from a material selected from the group of wood, metal and plastic and is built with sufficient cross sectional area and mass as to stably support the varying size of spinning ornaments for a particular design.

8. A rotatable display as in claim 6 wherein said motor is selected from the group of 12 volt or 110 volt motors sized to rotate the particular size and weight spinning ornament chosen.

9. A rotatable display as in claim 6 wherein said switch is a rheostat that allows variation of said motor speed.

10. A method of manufacture of an ornament comprised of the following steps:
providing a flat sheet of malleable metal with a front and back side;
forming said flat sheet with an outer perimeter in a shape selected from the group of round, oval, square, rectangular, pentagon, hexagon, octagon, heart or cloud shaped;
cutting concentric separation lines between a plurality of inscribed bands offset equidistantly from exterior band with the cuts stopping at the top and bottom center of said shape leaving a connection between the tracks;
cutting mounting holes in top and bottom of outer track;
cutting a wider separation channel between the innermost track and a center feature panel or pad;
cutting text or artwork in said panel;
sanding said front and back surfaces with grain perpendicular to axis through said mounting holes where by light is reflected toward viewer when ornament spins;
clamping said outer band, said inner band and said center feature and rotating each of said plurality of intermediary bands progressively by a small angle whereby the spinner ornament acquires a three dimensional shape;
applying a tinted but transparent coating to the surface of said ornament.

11. A method of manufacture of an ornament of claim 10 wherein
attaching text or artwork to said center panel is by way of decal or sticker.

12. A method of manufacture of an ornament of claim 10 wherein
selecting transparent tinted coating from the group of metallic flake painting, powder coating or plating;
applying selected coating to said ornament surfaces.
